(19) United States
(12) Patent Application Publication
(10) Pub. No.: US 2018/0233713 A1
(43) Pub. Date: Aug. 16, 2018

(54) CYLINDRICAL BATTERY CELL INCLUDING INORGANIC COATING PORTION

(71) Applicant: LG CHEM, LTD., Seoul-si (KR)

(72) Inventors: Byoung Gu LEE, Daejeon (KR); Do Gyun KIM, Daejeon (KR); Jun Tak KIM, Daejeon (KR); Hang Soo SHIN, Daejeon (KR); Byoung Kook LEE, Daejeon (KR); Sang Sok JUNG, Daejeon (KR)

(73) Assignee: LG CHEM, LTD., Seoul-si (KR)

(21) Appl. No.: 15/895,297

(22) Filed: Feb. 13, 2018

(30) Foreign Application Priority Data
Feb. 13, 2017 (KR) 10-2017-0019229

(51) Int. Cl. H01M 2/02; H01M 10/6551; H01M 10/04

(52) U.S. Cl. CPC H01M 2/0292; H01M 2/022; H01M 10/6551; H01M 2220/30; H01M 10/0431; H01M 10/0436; H01M 10/0422

(57) ABSTRACT

A cylindrical battery cell is provided. The cylindrical battery cell configured to have a structure in which a wound type electrode assembly having a positive electrode/separator/negative electrode structure is mounted in a cylindrical can. The cylindrical battery cell includes an inorganic coating portion for accelerating dissipation of heat from the cylindrical can, the inorganic coating portion being provided on at least a part of the outer surface of the cylindrical can.

The present application claims the benefit of Korean Patent Application No. 10-2017-0019229 filed in Korea on Feb. 13, 2017, which is hereby incorporated by reference.

### BACKGROUND

### Technical Field

The present invention relates to a cylindrical battery cell including an inorganic coating portion.

### Background Art

As mobile devices have been continually developed and the demand for such mobile devices has increased, the demand for secondary batteries as energy sources for such mobile devices has sharply increased. Among such secondary batteries is a lithium secondary battery, having high energy density and high discharge voltage, into which much research has been carried out and which is now commercialized and widely used.

Based on the shape of a battery case, secondary batteries are classified into a cylindrical battery having an electrode assembly mounted in a cylindrical metal can, a prismatic battery having an electrode assembly mounted in a prismatic metal can, and a pouch-shaped battery having an electrode assembly mounted in a pouch-shaped case made of an aluminum laminate sheet. Among these batteries, the cylindrical battery is applied to various kinds of devices due to the shape-related characteristics thereof.

In general, an electrode assembly is a power generating element configured to have a structure in which a positive electrode, a separator, and a negative electrode are stacked and configured so as to be capable of being charged and discharged. A jelly-roll type electrode assembly, which is configured to have a structure in which a long sheet type positive electrode and a long sheet type negative electrode, to which active materials are applied, are wound on a core in the state in which a separator is disposed between the positive electrode and the negative electrode, is used as an electrode assembly mounted in the cylindrical battery.

The jelly-roll type electrode assembly has advantages in that the electrode assembly can be easily manufactured and in that energy density per unit weight is high.

However, a cylindrical battery cell is configured to have a structure in which it is difficult to discharge heat generated in the battery cell out of the battery cell. When the battery cell is repeatedly charged and discharged, therefore, generation of heat from the center of the battery cell is accelerated, whereby the lifespan of the battery cell may be reduced. In addition, the battery cell may catch fire or explode.

Therefore, there is an urgent necessity for technology that is capable of greatly improving the cooling efficiency of the cylindrical battery cell.

### SUMMARY

Therefore, the present invention has been made to solve the above problems and other technical problems that have yet to be resolved.

Features and advantages of the invention will be set forth in the description which follows, and in part will be apparent from the description, or may be learned by practice of the invention. The objectives and other advantages of the invention may be realized and attained by the structure particularly pointed out in the written description and claims hereof as well as the appended drawings.

To achieve these and other advantages and in accordance with the purpose of the present invention, as embodied and broadly described, a cylindrical battery cell configured to have a structure in which a wound type electrode assembly having a positive electrode/separator/negative electrode structure is mounted in a cylindrical can, wherein the cylindrical battery cell comprises an inorganic coating portion for accelerating dissipation of heat from the cylindrical can, the inorganic coating portion being provided on at least a part of an outer surface of the cylindrical can.

It is to be understood that both the foregoing general description and the following detailed description are exemplary and explanatory and are intended to provide further explanation of the invention as claimed.

### DETAILED DESCRIPTION

Hereinafter, the present invention will be described in more detail with reference to the following examples. These examples are provided only for illustration of the present invention and should not be construed as limiting the scope of the present invention.

As a result of a variety of extensive and intensive studies and experiments to solve the problems described above, the inventors of the present application have found that, in the case in which an inorganic coating portion is provided on at least a part of the outer surface of a cylindrical battery cell, as will be described below, it is possible to achieved desired effects. The present invention has been completed based on these findings.

In accordance with example embodiments of the present invention, a cylindrical battery cell may be configured to have a structure in which a wound type electrode assembly having a positive electrode/separator/negative electrode structure is mounted in a cylindrical can, wherein the cylindrical battery cell includes an inorganic coating portion for accelerating the dissipation of heat from the cylindrical can, the inorganic coating portion being provided on at least a part of the outer surface of the cylindrical can.

In comparison, a related art cylindrical battery cell is configured to have a structure in which it is difficult to discharge heat generated in the battery cell out of the battery cell. As a result, heat that has not been discharged out of the battery cell when the battery cell is repeatedly charged and discharged may deteriorate the interior of the battery cell, whereby the battery cell may catch fire or explode.

In the cylindrical battery cell according to embodiments of the present invention, the battery case may include an inorganic coating portion. The heat generated in the cylindrical battery cell may move to the inorganic coating portion, through which the discharge of heat to the outside may be accelerated.

In addition, a negative electrode tab of the electrode assembly may be connected to the cylindrical can, which is made of a metal material. As a result, current flows along the surface of the cylindrical can during the operation of the battery cell. In the case in which the inorganic coating portion is provided on at least a part of the outer surface of the cylindrical can, it is possible to improve the insulation value of the battery cell.

The cylindrical can may be made of anticorrosion-plated iron or stainless steel.

Inorganic particles of the inorganic coating portion may absorb heat generated and conducted in the cylindrical can, may convert at least a part of the heat energy into light energy, and may emit the light energy to the outside.

In an example embodiment, the inorganic particles may emit both heat energy and light energy.

Generally, in the case in which only heat energy is emitted from the inorganic particles, heat generated from a heat source is diffused over the entire heat dissipation area, whereby the temperature of the heat source is reduced. In this case, if the difference in temperature between the heat source and the heat dissipation area is large, heat dissipation is effectively achieved. If the entire heat dissipation area has a temperature similar to the temperature of the heat source, however, heat diffusion speed may be reduced, whereby heat dissipation efficiency may be reduced.

On the other hand, when the inorganic particles emit light energy, the inorganic particles absorb heat energy generated from the heat source as an energy source. In this case, the highest occupied molecular orbital (HOMO) state of electrons is changed to the lowest unoccupied molecular orbital (LUMO) state. Electrons in the LUMO state, e.g., unstable electrons, emit light energy, whereby the state of the electrons returns to the HOMO state. As a result, the temperature of the heat source may be reduced. In the case in which the inorganic particles emit light energy, therefore, heat dissipation may be performed without a reduction in efficiency even when the entire heat dissipation area has a temperature similar to the temperature of the heat source. Particularly, in the present invention, the inorganic particles emit both heat energy and light energy. Consequently, all of the above-mentioned advantages may apply to the present invention.

The inorganic coating portion may be an inorganic coating layer composed of only inorganic particles or an inorganic coating sheet including the inorganic particles.

The inorganic coating layer may be composed of inorganic particles, and the inorganic particles may include metal oxide particles. Consequently, the battery case is insulated by the metal oxide particles, whereby the safety of the battery cell may be improved.

Also, in the case in which the inorganic coating portion is an inorganic coating sheet including the inorganic particles, the process is completed merely by attaching the inorganic coating sheet to the cylindrical can, whereby it is possible to manufacture the battery cell more easily than when using other manufacturing methods.

For example, the inorganic coating sheet may include an inorganic material, a substrate having the inorganic material applied thereto, and an adhesion layer for sheet attachment. In addition, an adhesive constituting the adhesion layer includes a small amount of metal powder. Consequently, it is possible to rapidly transfer the heat discharged from the battery case to the inorganic coating layer.

The substrate constituting the inorganic coating sheet may be at least one selected from among polyester, polyethylene terephthalate, polystyrene, polypropylene, polyethylene naphthalate, polyether sulfone, polyphenylene sulfide, polyimide, and polyether imide. For example, a polyester film may be used.

The inorganic material that is coated on the substrate may be a paint having a urethane-based heat dissipation filler or binder coupled thereto.

In addition, an acryl-based emulsion resin including an acrylate monomer may be used as the adhesive constituting the adhesion layer for sheet attachment. In order to improve thermal conductivity and heat dissipation, metal powder or graphite may be further added to the adhesive. Metal powder that exhibits low reactivity, such as nickel powder or copper powder, may be used as the metal powder such that the metal powder is prevented from being thermally oxidized.

In another example, the cylindrical battery cell may further include an electrically insulative heat-shrinkable tube interposed between the cylindrical can and the inorganic coating portion.

A negative electrode tab of the electrode assembly may be connected to the cylindrical can, which is made of a metal material. As a result, current flows along the surface of the cylindrical can, whereby the battery case is not insulated. In order to solve this problem, an electrically insulative heat-shrinkable tube may be used. However, the electrically insulative heat-shrinkable tube may block direct heat transfer between the cylindrical battery cell and air, whereby heat dissipation is impeded.

In the case in which the heat-shrinkable tube is interposed between the metal can and the inorganic coating portion, heat transferred from the cylindrical battery cell to the heat-shrinkable tube is transferred to the inorganic coating portion while the insulation value of the battery case is further improved, whereby the dissipation of heat to the outside is accelerated.

In one example, the inorganic coating layer may be manufactured by dispersing inorganic particles in a specific solvent to manufacture an inorganic coating solution, applying the inorganic coating solution to the surface of the heat-shrinkable tube, and naturally drying or thermally treating the inorganic coating solution.

The inorganic particles of the inorganic coating portion may include at least one selected from the group consisting of Mg, Al, Si, Ca, Ti, and Zr. For example, the inorganic particles may be at least one selected from the group consisting of Ti, Si, and Ca.

For example, an alloy of Ti may be used as the inorganic particles.

A mixture of a high boiling point organic solvent selected from among butyl cellosolve, cellosolve acetate, and propylene glycol methyl ether acetate and a middle boiling point organic solvent selected from among xylene and toluene may be used as the solvent that is used to manufacture the inorganic coating solution. Further, the solvent that is used to manufacture the inorganic coating solution may be used within a range of 10 to 50 weight % of the total weight of the inorganic coating solution.

The heat-shrinkable tube may be made of at least one selected from among polyethylene terephthalate, polyester, polystyrene, polypropylene, and polyethylene naphthalate. For example, a polyethylene terephthalate film may be used.

The inorganic coating portion may be coated so as to have a thickness equivalent to 1% to 30% of the total thickness of the cylindrical can.

If the thickness of the inorganic coating portion is less than 1% of the total thickness of the cylindrical can, the amount of inorganic particles is too insufficient to perform heat dissipation, whereby it is difficult to exhibit desired heat dissipation performance.

On the other hand, if the thickness of the inorganic coating portion is greater than 30% of the total thickness of the cylindrical can, cracks may occur in the inorganic coating portion, and costs related to the inorganic coating portion may increase.

Meanwhile, in the case in which the inorganic coating portion is applied over the heat-shrinkable tube, cracks may more easily occur in the inorganic coating portion due to the shrinkage of the tube. In order to solve this problem, the inorganic coating portion may be coated so as to have a thickness equivalent to 1% to 20% of the total thickness of the cylindrical can and the heat-shrinkable tube.

Meanwhile, in the cylindrical battery cell according to the present invention, the cylindrical can may have a thickness of 50 to 500 μm. If the thickness of the cylindrical can is less than 50 μm, it is difficult to sufficiently protect the electrode assembly from external impacts, which is undesirable. If the thickness of the cylindrical can is greater than 500 μm, energy density with respect to the size of the battery cell is reduced, which is undesirable.

In addition, the heat-shrinkable tube may have a thickness of 20 to 100 μm. If the thickness of the heat-shrinkable tube is less than 20 μm, the tube may be melted by heat generated from the cylindrical can, may be ruptured due to external impacts, or may be damaged due to the weight of the inorganic coating portion, whereby the insulation function and safety of the tube are greatly reduced. If the thickness of the heat-shrinkable tube is greater than 100 μm, heat transfer from the cylindrical can to the inorganic coating portion is delayed, whereby the heat dissipation effect is reduced. Furthermore, shrinkage deviation may locally occur in the heat-shrinkable tube, whereby the external appearance of the heat-shrinkable tube may be deteriorated.

In accordance with other aspects of the present invention, there are provided a battery module including the battery cell as a unit cell, a battery pack including the battery module, and a device including the battery pack as a power source.

An example of the device may be any one selected from among a power tool driven by a battery-powered motor, an electric automobile, such as an electric vehicle (EV), a hybrid electric vehicle (HEV), or a plug-in hybrid electric vehicle (PHEV), an electric two-wheeled vehicle, such as an electric bicycle (E-bike) or an electric scooter (E-scooter), an electric golf cart, and a power storage system. However, the present invention is not limited thereto.

Example configurations will be described below.

### Example 1

20 weight % of heat dissipation powder, 5 weight % of a binder, 74 weight % of a solvent, and 1 weight % of a dispersion additive were mixed, stirred, and dispersed in order to manufacture an inorganic coating solution. Subsequently, the inorganic coating solution was applied to the surface of a cylindrical can having a thickness of 150 μm through spray coating such that the inorganic coating solution had a thickness of 40 μm in order to manufacture a cylindrical battery cell having an inorganic coating portion formed thereon.

### Example 2

A cylindrical battery cell was manufactured in the same manner as in Example 1 except that an inorganic coating sheet manufactured using the inorganic coating solution used in Example 1 was attached to the surface of a cylindrical can having a thickness of 150 μm.

### Example 3

A cylindrical battery cell was manufactured in the same manner as in Example 1 except that the inorganic coating solution used in Example 1 was applied to a tube made of polyethylene terephthalate (PET) through spray coating in order to form an inorganic coating layer, the tube was fitted onto a cylindrical can, and the tube was dried using hot air having a temperature of 90° C. in order to shrink the tube.

### Comparative Example 1

A tube made of polyethylene terephthalate (PET) was fitted onto a cylindrical can, and the tube was dried using hot air having a temperature of 150 to 200° C. in order to shrink the tube, whereby a cylindrical battery cell was manufactured.

### Experimental Example 1

The cylindrical battery cells manufactured according to Examples 1 to 3 and Comparative Example 1 were discharged at a high speed, and the temperatures of the cylindrical battery cells manufactured according to Examples 1 to 3 were compared with the temperature of the cylindrical battery cell manufactured according to Comparative Example 1. The results are shown in Table 1 below.

TABLE 1

| | | | | Comparative |
|---|---|---|---|---|
| | | | | Example 1 |
| | Example 1 | Example 2 | Example 3 | (Tube was fitted |
| | (Inorganic | (Inorganic | (Inorganic | onto can |
| | coating solution | coating sheet | coating layer | without |
| | was applied to | was attached to | was formed on | inorganic |
| Set | surface of can) | surface of can) | tube) | coating portion) |
| Temperature of | 83.28 | 84.74 | 85.99 | 93.02 |
| battery cell | | | | |
| when | | | | |
| discharged at | | | | |
| high speed (° C.) | | | | |
| Difference in | 9.74 | 8.28 | 7.03 | — |
| temperature | | | | |
| from | | | | |
| Comparative | | | | |
| Example 1 (Δt, | | | | |
| ° C.) | | | | |
| Emission ratio | 10.5 | 8.9 | 7.6 | — |
| to Comparative | | | | |
| Example 1 (%) | | | | |

It can be seen from Table 1 that Example 1, in which the inorganic coating portion was directly applied to the surface of the cylindrical can, Example 2, in which the inorganic coating sheet was attached to the surface of the cylindrical can, and Example 3, in which the inorganic coating layer was formed on the heat-shrinkable tube, have temperatures lower than the temperature of Comparative Example 1. That is, it can be seen that Examples 1 to 3 exhibit a heat dissipation effect higher than the heat dissipation effect of Comparative Example 1.

As may be apparent from the above description, the cylindrical battery cell according to the present invention includes an inorganic coating portion provided on the outermost surface thereof. As a result, it is possible to effectively remove heat generated in the battery cell during the charge and discharge of the battery cell, whereby it is possible to greatly improve the cooling efficiency of the cylindrical battery cell and to prevent deterioration of the battery cell. Consequently, it is possible to improve the safety and lifespan characteristics of the battery cell.

Although exemplary embodiments of the present invention have been disclosed for illustrative purposes, those skilled in the art will appreciate that various modifications, additions and substitutions are possible, without departing from the scope and spirit of the invention as disclosed in the accompanying claims.

1. A cylindrical battery cell configured to have a structure in which a wound type electrode assembly having a positive electrode/separator/negative electrode structure is mounted in a cylindrical can, wherein
the cylindrical battery cell comprises an inorganic coating portion for accelerating dissipation of heat from the cylindrical can, the inorganic coating portion being provided on at least a part of an outer surface of the cylindrical can.

2. The cylindrical battery cell according to claim 1, wherein the cylindrical can is made of anticorrosion-plated iron or stainless steel.

3. The cylindrical battery cell according to claim 1, wherein the inorganic coating portion is an inorganic coating layer composed of only inorganic particles or an inorganic coating sheet comprising the inorganic particles.

4. The cylindrical battery cell according to claim 3, wherein the cylindrical battery cell further comprises an electrically insulative heat-shrinkable tube interposed between the cylindrical can and the inorganic coating portion.

5. The cylindrical battery cell according to claim 4, wherein the heat-shrinkable tube has a thickness of 20 to 100 μm.

6. The cylindrical battery cell according to claim 1, wherein the inorganic coating portion is coated over an entirety of the outer surface of the cylindrical can.

7. The cylindrical battery cell according to claim 1, wherein inorganic particles of the inorganic coating portion absorb heat generated and conducted in the cylindrical can, convert at least a part of heat energy into light energy, and emit the light energy to an outside.

8. The cylindrical battery cell according to claim 7, wherein the inorganic particles emit both heat energy and light energy.

9. The cylindrical battery cell according to claim 1, wherein the inorganic coating portion comprises at least one selected from a group consisting of Mg, Al, Si, Ca, Ti, and Zr.

10. The cylindrical battery cell according to claim 1, wherein the inorganic coating portion is coated so as to have a thickness equivalent to 1% to 30% of a thickness of the cylindrical can.

11. The cylindrical battery cell according to claim 10, wherein the cylindrical can has a thickness of 50 to 500 μm.

12. A battery module comprising at least one cylindrical battery cell according to claim 1.

13. A battery pack comprising a battery module according to claim 12.
